(19) United States
(12) Patent Application Publication
(10) Pub. No.: US 2015/0369333 A1
(43) Pub. Date: Dec. 24, 2015

(54) Torsional Vibration Damping Arrangement For The DriveTrain Of A Vehicle

(71) Applicant: ZF FRIEDRICHSHAFEN AG, Friedrichshag (DE)

(72) Inventors: Uwe GROBGEBAUER, Erlabrunn (DE); Thomas WEIGAND, Schweinfurt (DE)

(21) Appl. No.: 14/764,946

(22) PCT Filed: Jan. 9, 2014
(86) PCT No.: PCT/EP2014/050287

§ 371 Date: Jul. 30, 2015

(30) Foreign Application Priority Data
Jan. 31, 2013 (DE) 10 2013 201 617.4

(51) Int. Cl. F16F 15/121; F16H 3/44

(52) U.S. Cl. CPC F16F 15/121; F16H 3/44

(57) ABSTRACT

A torsional vibration damping arrangement for a drivetrain of a vehicle has an input region driven in rotation around an axis of rotation A, an output region, a first torque transmission path and parallel thereto a second torque transmission path that each proceed from the input region, a coupling arrangement communicating with the output region for superposing the torques guided via the torque transmission paths, and a phase shifter arrangement for the first torque transmission path for generating a phase shift of rotational irregularities guided via the first torque transmission path relative to rotational irregularities guided via the second torque transmission path. An output element of the phase shifter arrangement forms a planet gear carrier of the coupling arrangement, at least one planet gear being rotatably supported thereon.

### CROSS REFERENCE TO RELATED APPLICATIONS

This is a U.S. national stage of application No. PCT/EP2014/050287, filed on Jan. 9, 2014. Priority is claimed on German Application No DE102013201617.4, filed Jan. 31, 2013, the content of which is incorporated here by reference.

### BACKGROUND OF THE INVENTION

1. Field of the Invention

The present invention is directed to a torsional vibration damping arrangement for the drivetrain of a vehicle, having an input region driven in rotation around an axis of rotation and an output region. Provided between the input region and the output region are a first torque transmission path and a second torque transmission path parallel thereto and a coupling arrangement for superposing the torques guided via the torque transmission paths. A phase shifter arrangement is provided in the first torque transmission path to generate a phase shift of rotational irregularities guided via the first torque transmission path relative to rotational irregularities guided via the second torque transmission path.

2. Detailed Description of Prior Art

A generic torsional vibration damping arrangement known from German Patent Application DL 10 2011 007 118 A1 divides the torque introduced into an input region through a crankshaft of a drive unit, into a torque component transmitted via a first torque transmission path and a torque component guided via a second torque transmission path. Not only is there a static torque divided in this torque division, but the vibrations and rotational irregularities which are generated by the periodically occurring ignitions in a drive unit and which are contained in the torque to be transmitted are also divided proportionately into the two torque transmission paths. The torque components transmitted via the two torque transmission paths are brought together again in a coupling arrangement constructed as a planetary gear set with a planet gear carrier and are then introduced as a total torque into the output region a friction clutch or the like.

A phase shifter arrangement having an input element and an output element is provided in at least one of the torque transmission paths. This phase shifter arrangement is constructed in the manner of a vibration damper, i.e., has a primary side and a secondary side which is rotatable with respect to the primary side through the compressibility of a spring arrangement. In particular when this vibration system passes into a supercritical state, i.e., when it is excited with vibrations exceeding the resonant frequency of the vibration system, a phase shift of up to 180° occurs. This means that at maximum phase displacement the vibration components proceeding from the vibration system are shifted in phase by 180° with respect to the vibration components received by the vibration system. Since the vibration components guided via the other torque transmission path do not undergo a phase shift or, if so, a different phase shift, the vibration components contained in the unified torque components and, which are then shifted in phase with respect to one another, are destructively superposed on one another such that, ideally, the total torque introduced into the output region is a static torque which contains essentially no vibration components.

### SUMMARY OF THE INVENTION

It is an object of the present invention to develop a torsional vibration damping arrangement in such a way that it has a further improved vibration damping behavior and occupies a small axial installation space.

According to one embodiment of the invention, a torsional vibration damping arrangement for the drivetrain of a vehicle, comprises an input region driven in rotation around an axis of rotation A and an output region, wherein there are provided between the input region and the output region a first torque transmission path and parallel thereto a second torque transmission path, and a coupling arrangement communicating with the output region for superposing the torques guided via the torque transmission paths, and wherein a phase shifter arrangement is provided in the first torque transmission path for generating a phase shift of rotational irregularities guided via the first torque transmission path relative to rotational irregularities guided via the second torque transmission path. The output element of the phase shifter arrangement forms the planet gear carrier on which the planet gear is rotatably supported. In previous embodiment forms of the torsional vibration damping arrangement with a planetary gear set as coupling arrangement, the planet gear carrier is located in a torque transmission path having no phase shifting. Therefore, the planet gear carrier was usually rigidly connected to the primary mass. Because the output element of the phase shifter arrangement forms the planet gear carrier of the coupling arrangement and is accordingly located in a phase-shifted path, the path without phase shifting is in this case connected to the primary mass and coupling arrangement by means of a drive sun gear. An output sun gear connects the output region to the coupling arrangement. In so doing, the output sun gear is connected to the output region to be fixed with respect to rotation relative to it and meshes with the planet gear.

The phase shifter arrangement can comprise at least one spring set which advantageously comprises a coil spring. When at least two spring sets are used, these two spring sets can be arranged so as to operate in parallel or in series.

The torque that can come from an output of a drive unit, formed by a crankshaft, can be divided and transmitted by the torsional vibration damping arrangement in a manner described in the following.

When a torque path proceeds in axial direction around the axis of rotation A from the input region to the output region, the spring set is acted upon in the first torque transmission path by a first torque via the primary mass. The first torque proceeds from the spring set via an output element to the planet gear carrier. The planet gear carrier rotatably receives the planet gear.

In the second torque transmission path, the second torque reaches a drive sun gear connected to the input region to be fixed with respect to rotation relative to it. The drive sun gear meshes with the planet gear. Consequently, the first torque and second torque are reunited at the planet gear. Due to the fact that the first torque undergoes a phase shift by the phase shifter arrangement in the first torque transmission path, the phase-shifted first torque and the second torque, which is not phase-shifted are ideally destructively superposed at the planet gear such that the torsional vibrations which can come from the drive unit of an internal combustion engine are compensated by the superposition, and a torque without torsional vibrations can be guided further to the output sun gear that meshes with the planet gear. Accordingly, the torsional vibration in the torque present in the input region of the torsional vibration damping arrangement is compensated in that the torque is split into a first torque and a second torque and, therefore, into two torque transmission paths, in that the phase is shifted by means of the phase shifter arrangement in the first torque transmission path, in that the torque is conveyed in the second torque transmission path without being phase-shifted, and the first torque and second torque are destructively superposed in the coupling arrangement, and ideally a torque without torsional vibrations reaches the output region and, therefore, arrives at, e.g., a friction clutch, a converter or the like structural component part.

In an advantageous embodiment, the coupling arrangement comprises a first input part and a second input part into which torques guided via the first torque transmission path and second torque transmission path are introduced and a superposition unit in which the introduced torques are combined again and an output part, which conveys the combined torque, for example, to a friction clutch. The first input part is connected in operative direction thereof to the phase shifter arrangement on one side and to the superposition unit on the other side. The second input part is connected in operative direction thereof to the input region on one side and to the superposition unit on the other side. The superposition unit is in turn connected in operative direction thereof to both the first input part and second input part on one side and to the output part on the other side. The output part forms the output region and can receive a friction clutch in an advantageous embodiment.

To achieve the phase shift in a simple manner in one of the torque transmission paths, the phase shifter arrangement comprises a vibration system with a primary mass and a secondary mass that is rotatable with respect to the primary mass around the axis of rotation A against the action of a spring arrangement. A vibration system of this type can be constructed as a kind of vibration damper, known per se, in which the resonant frequency of the vibration system can be adjusted in a defined manner, particularly by influencing the primary-side mass and secondary-side mass as well as the stiffness of the spring arrangement, and the frequency at which there is a transition to the supercritical state can accordingly also be determined.

In an advantageous embodiment, the intermediate element comprises an additional mass element connected to the planet gear carrier so as to be fixed with respect to rotation relative to it. Through the use of the additional mass element, a mass inertia of the intermediate element and, therefore, also a mass inertia of the planet gear carrier can be changed. By changing the mass inertia of the planet gear carrier, the entire phase shifter arrangement can be tuned. This change in the mass moment of inertia of the intermediate element can have a particularly positive result for the phase rotation and, therefore, for the decoupling quality of the entire torsional vibration damping arrangement.

In a further advantageous embodiment, the planetary gear set comprises a drive sun gear and an output sun gear. The drive sun gear is connected to the primary mass to be fixed with respect to rotation relative to it, the output sun gear is connected to the output region so as to be fixed with respect to rotation relative to it, and the drive sun gear and output sun gear mesh with the planet gear. As a result of this embodiment, the coupling arrangement can be constructed in an axially compact manner because the drive sun gear and the output sun gear are arranged radially within the planet gear, and the axial extension is accordingly determined by the planet gear. This means that the axial extension of the planet gear is a determining factor for the axial extension of the coupling arrangement.

In a further advantageous embodiment, the planetary gear set can comprise a drive ring gear and an output ring gear. The drive ring gear is connected to the primary mass so as to be fixed with respect to rotation relative to it and the output ring gear is connected to the output region so as to be fixed with respect to rotation relative to it, and the drive ring gear and output ring gear mesh with the planet gear. This variant is particularly advantageous when the radial installation space within the coupling arrangement does not permit the use of sun gears. In this case too, the intermediate element comprises the planet gear carrier as is also the case with the above-mentioned embodiment with sun gears.

In a further advantageous embodiment, the phase shifter arrangement and the coupling arrangement are at least partially received in a wet space which is at least partially filled with a fluid. The wet space at least partially comprises an inner region of the torsional vibration damping arrangement. The wet space can be bounded outwardly by at least one element forming a housing portion, e.g., the primary mass and a cover plate on the transmission side. Sealing is preferably carried out by sealing elements in the radially inner region around the axis of rotation A in order to achieve reduced friction at the sealing elements through a reduced friction diameter at the sealing elements. When drive sun gears and output sun gears are used, the sealing elements can advantageously be positioned between the elements that are rotatable relative to one another, such as the drive sun gear and output sun gear, and between output sun gear and the transmission-side sealing plate. The positioning of the sealing elements can preferably be selected such that the torsional vibration damping arrangement can be screwed, e.g., to the crankshaft of the drive unit, through a through-hole radially inside of the sealing elements by at least one crankshaft screw. This is advantageous with respect to mounting the torsional vibration damping arrangement at the drive unit. The wet space can preferably be filled at least partially with a lubricant such as oil or grease in order to minimize wear and friction.

### BRIEF DESCRIPTION OF THE DRAWINGS

Preferred embodiment examples of the invention will be described in the following with reference to the accompanying drawings. The drawings show:

FIG. 1 is a schematic torsional vibration damping arrangement with a planetary gear set as a coupling arrangement, wherein the planetary gear set comprises a drive sun gear and an output sun gear;

FIG. 2 is a schematic torsional vibration damping arrangement with a planetary gear set as a coupling arrangement, wherein the planetary gear set comprises a drive ring gear and an output ring gear; and

FIG. 3 is a torsional vibration damping arrangement as constructional implementation with the constructional features mentioned referring to FIG. 1.

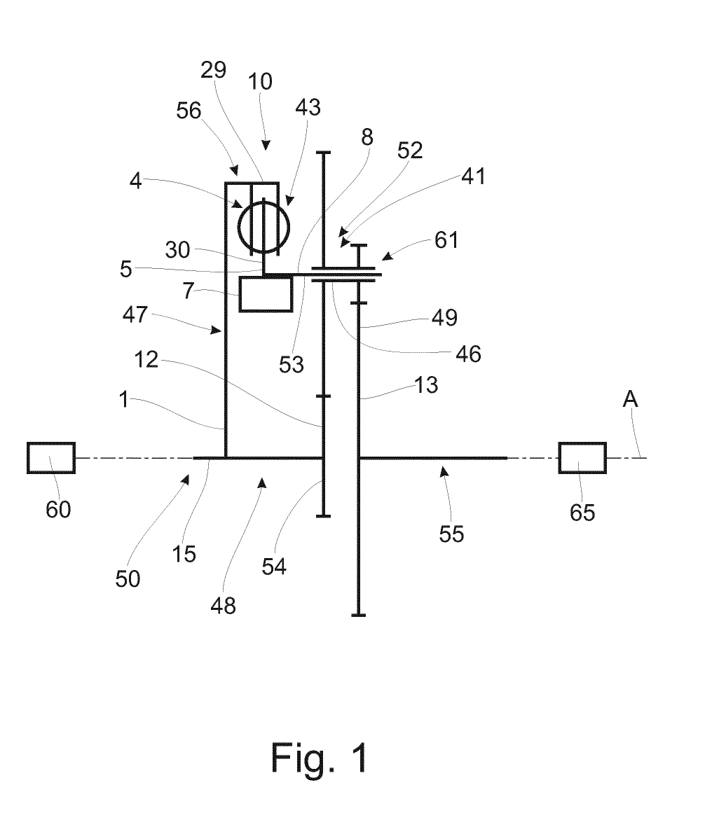

A torsional vibration damping arrangement 10 that operates on the principle of power splitting or torque splitting is shown schematically in FIG. 1. The torsional vibration damping arrangement 10 can be arranged in a drivetrain of a vehicle between a drive unit 60 and the subsequent portion of the drivetrain, i.e., for example, a start-up element 65 such as a friction clutch, a hydrodynamic torque converter, or the like.

The torsional vibration damping arrangement 10 comprises an input region, designated generally by 50. In the input region 50, the torque received from the drive unit 60, for example, an internal combustion engine, via a crankshaft 15 branches into a first torque transmission path 47 and a second torque transmission path 48. In the region of a coupling arrangement designated generally by reference numeral 41 and which may also be referred to as a superposition unit 52 and is constructed in this instance as a planetary gear set, the torque components guided via the two torque transmission paths 47, 48 are introduced into the coupling arrangement 41 by a first input part 53 formed by a planet gear carrier 8 and a second input part 54 formed by a drive sun gear and are combined again therein. The planet gear 46, which meshes with the drive sun gear 12, is rotatably supported on the planet gear carrier 8. Via an output part 49 formed with an output sun gear 13 likewise meshes with the planet gear 46 and is connected to an output region 55 so as to be fixed with respect to rotation relative to it, the torque can be guided to a start-up element 65 which is connected to the output region so as to be fixed with respect to rotation relative to it.

A vibration system, designated generally by reference numeral 56, is integrated in the first torque transmission path 47. The vibration system 56 acts as a phase shifter arrangement 43 and comprises a primary mass 1 connected, for example, to the drive unit 60 and a spring arrangement 4 connected to the primary mass 1 via an input element 29. An output element 30 of the spring arrangement 4 is further connected to an intermediate element 5 which in this instance also comprises an additional mass element 7 and forms the planet gear carrier 8 in this instance. This is in contrast to the previously known embodiment in which the planet gear carrier 8 was positioned in the torque transmission path and rigidly connected to the primary mass 1. In the embodiment described here, the planet gear carrier 8 is positioned in the torque transmission path, in this case the first torque transmission path 47, in which the torsional irregularities guided via the first torque transmission path 47 are phase-shifted with respect to the torsional irregularities guided via the second torque transmission path 48. Due to the fact that the output element 30 of the spring arrangement 4 is connected to the planet gear carrier 8, the phase shifter arrangement 43 and coupling arrangement 41 form a unit which is compact in axial extension. It is also positive that the mass moments of inertia of the planet gear carrier 8 and planet gear 46 are included in the mass inertia of the intermediate element 5.

A torque in the first torque transmission path 47 can proceed from the drive unit 60 via the primary mass 1 into the spring arrangement 4. The first torque is guided from the spring arrangement 4 via the output element 30 and intermediate element 5 to the planet gear carrier 8 which rotatably receives the planet gear 46. The output element 30, intermediate element 5, additional mass element 7 and planet gear carrier 8 are connected to one another so as to be fixed with respect to rotation relative to one another and accordingly form a unit.

In the second torque transmission path 48, the second torque is guided from the drive unit 60 into a drive sun gear 12 connected to the latter so as to be fixed with respect to rotation relative to it. The drive sun gear 12 meshes with the planet gear 46 and accordingly guides the second torque to the planet gear 46 of the coupling arrangement 41.

Consequently, the first torque and second torque arrive via the two torque transmission paths 47 and 48 at the planet gear 46, where they are guided together again. The output sun gear 13, which meshes with the planet gear 46, takes off the combined torque from the planet gear 46 and guides it to the output region 55 to which the start-up element 65, for example, a friction clutch or a torque converter, not shown here. can be fastened.

Therefore, this construction of the torsional vibration damping arrangement 10 is characterized by a greater mass inertia in the intermediate element 5 without increasing the total mass inertia because the mass inertia of the planet gear carrier 8 and planet gear 46 are included in the mass inertia of the intermediate element 5. Through the use of the drive sun gear 12 and the output sun gear 13 radially inside of the planet gear 46, a more compact axial installation space can be provided. Further, only structural component parts having an external toothing are used for this purpose. This is particularly advantageous with respect to production costs.

This embodiment form of the torsional vibration damping arrangement 10 is particularly suitable for installing in vehicles with transverse front-mounted engine because the available axial installation space is often smaller compared to longitudinally mounted engines. However, application is not limited thereto, but can also be carried out in any other vehicle installation space.

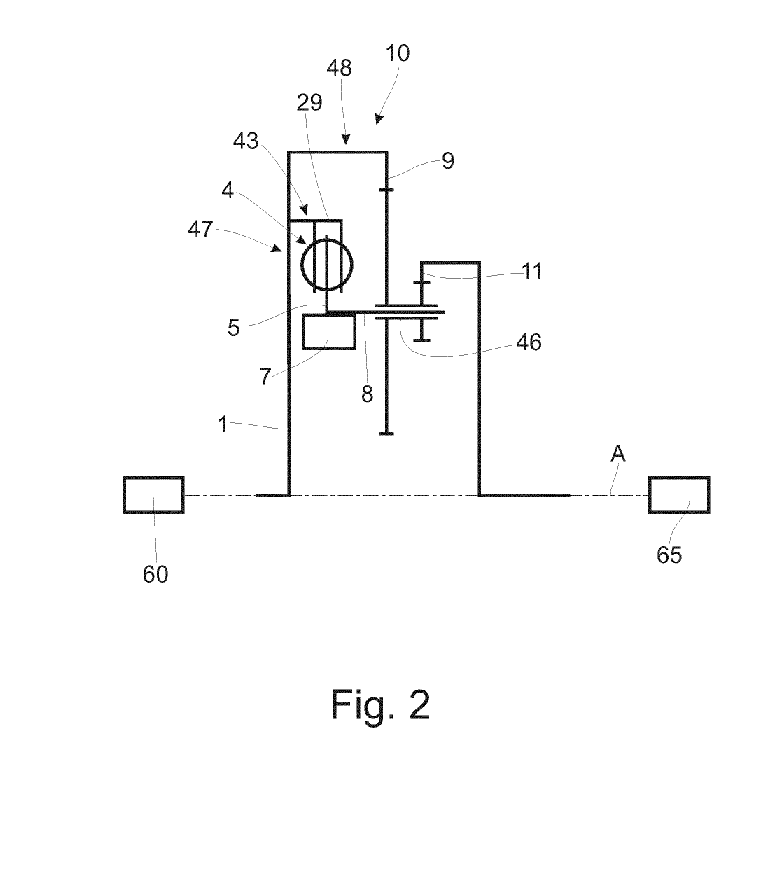

FIG. 2 shows a torsional vibration damping arrangement 10 like that in FIG. 1. In this case also, the torque comes from the drive unit 60 and is guided further via the primary mass 1. However, in this case the second torque in the second torque transmission path 48 is guided to the planet gear 46 via a drive ring gear 9, which meshes with the planet gear 46. The path of the first torque in the first torque transmission path 47 is as described with reference to FIG. 1 and runs from the primary mass 1 via the input element 29 into the phase shifter arrangement 43 with the spring element 4. The first torque passes from the spring element 4 via the intermediate element 5 to the planet gear carrier 8, which is connected to the intermediate element 5 so as to be fixed with respect to rotation relative to it. If desirable, depending on the configuration of the torsional vibration damping arrangement 10, the additional mass element 7 can, as is shown here, be connected to the intermediate element 5 so as to be fixed with respect to rotation relative to it in order to increase the mass inertia of the intermediate element 5. The planet gear 46 is rotatably supported at the planet gear carrier 8. The first torque and second torque are combined at the planet gear 46 and are taken off in this case by an output ring gear 11, which meshes with the planet gear 46 and, as described with reference to FIG. 1, are guided to the start-up element 65. Both the drive ring gear 9 and the output ring gear 11 are positioned radially outwardly of the planet gear 46 with respect to the axis of rotation A. This embodiment form is particularly advantageous when there is no installation space available radially inwardly of the torsional vibration damping arrangement 10 for the drive sun gear 12 and output sun gear 13 described with reference to FIG. 1. The other advantages are the same as those mentioned already referring to FIG. 1.

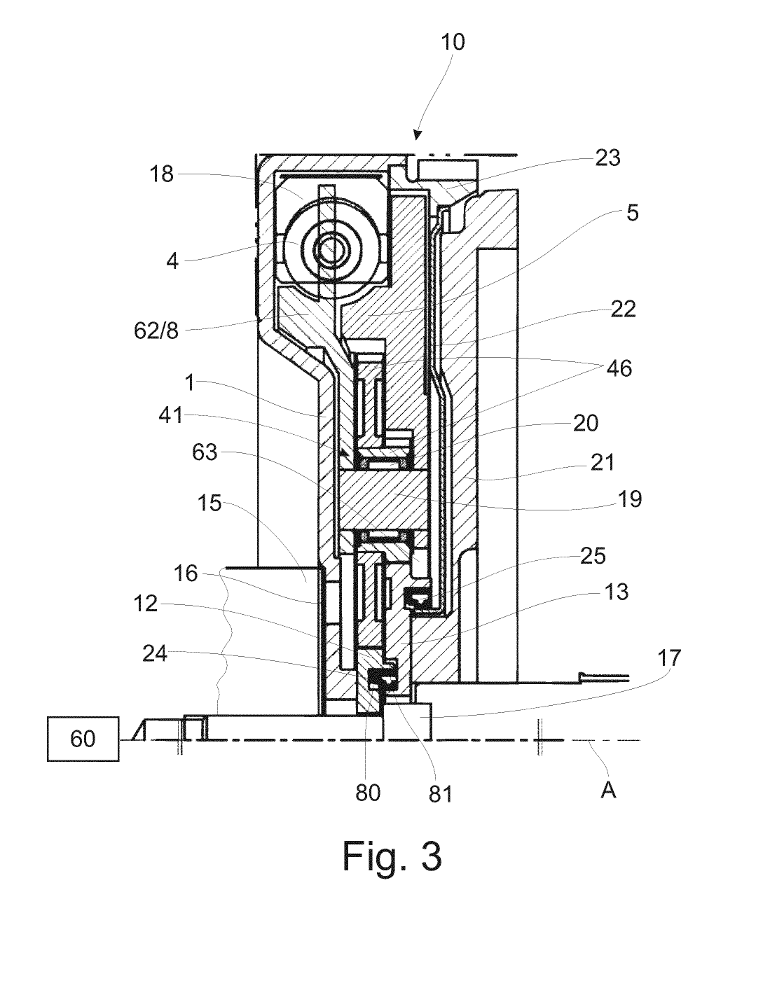

FIG. 3 shows a torsional vibration damping arrangement 10 as in FIG. 1 but as constructional implementation.

The primary mass 1 is connected in this case to a crankshaft 15 of a drive unit 60 so as to be fixed with respect to rotation relative to it. This connection is realized by a Hirth coupling 16 and a central screw 17. Although not shown here, connection is also possible by a Hirth coupling and screwing through the toothed surface, a standard crankshaft screw connection or connecting by means of a flexplate. However, the Hirth coupling 16 with central screw 17 affords the possibility of greater freedom in configuring the coupling arrangement 41 because the radial installation space inside the torsional vibration damping arrangement 10 is reduced as a result of this way of connecting the crankshaft 15 and primary mass 1. On the one hand, the spring arrangement 4 is actuated by the primary mass 1 via a sliding block 18. On the other hand, the spring arrangement 4 is connected in the torque path via a hub disk 62 which forms the planet gear carrier 8 farther radially inside. As has already been described, the mass moment of inertia of the planet gear carrier 8 is simultaneously the mass moment of inertia of the intermediate element 5. The mass moment of inertia of the intermediate element 5 is as large as possible in this constructional variant in order to achieve a good decoupling effect of the entire torsional vibration damping arrangement 10. Accordingly, this constructional variant makes it possible to achieve considerably more mass inertia of the intermediate element 5 than in previous constructional variants with the installation space remaining the same. Naturally, the mass moment of inertia of the intermediate element 5 can be reduced in case of less stringent requirements for decoupling quality or less available installation space or if the aim is a lower overall mass moment of inertia or lower weight. Further, the planet gear carrier 8 is supported in a floating manner in this constructional variant and is centered solely via the toothing. In a constructional variant which is not shown, the planet gear carrier 8 can also be supported relative to the primary mass 1 or relative to a secondary flywheel 21. Located at the planet gear carrier 8 is a planet gear bolt 19 on which the planet gear 46 is supported at the planet gear carrier 8 by a planet gear bearing 20 that can be constructed as a rolling element bearing or plain bearing. In this constructional variant, the planet gear 46 is stepped and is formed of two parts. A connection of the two gears can be produced, for example, via a weld joint or the like non-detachable or detachable bonding or frictionally engaging joining process. The drive sun gear 12 is connected to the primary mass 1 so as to be fixed with respect to rotation relative to it by welding, screwing, riveting or an equivalent method. In a constructional variant, not shown here, a one-piece construction of primary mass 1 and drive sun gear 12 is also possible. The output sun gear 13 is screwed, riveted or welded to the secondary flywheel 21 so as to be fixed with respect to rotation relative to it or is connected by an equivalent joining method. In order to allow the torsional vibration damping arrangement 10 to be filled with a lubricant such as oil or grease in the inner region thereof, which can also be referred to as wet space 63, so as to ensure a sufficient lubrication of the toothing, a sealing plate 22 is positioned between the intermediate element 5 and the secondary flywheel 21. In this case, the radially outer region of the sealing plate 22 is connected to a starter ring gear 23 so as to be fixed with respect to rotation relative to it and so as to be liquid-tight, this starter ring gear 23 itself being connected to the intermediate element 5 so as to be fixed with respect to rotation relative to it. A secondary sealing element 25, preferably constructed as a radial shaft seal in this instance, is positioned in the radially inner region of the sealing plate 22 and connects the sealing plate 22 and output sun gear 13 so as to be rotatable relative to one another in such a way that the relative rotation of these two structural component parts with respect to one another is possible without lubricant escaping from the wet space 63. In an embodiment form, not shown here, the sealing plate 22 can also be directly connected to the primary mass so as to be fixed with respect to rotation relative to it and liquid-tight. Further, a sun gear sealing element 24 is positioned between the drive sun gear 12 and the output sun gear 13. By a waisted recess 80 and 81 radially inwardly at the front side of the two sun gears 12 and 13, the sun gear sealing element 24 can be positioned in such a way that no additional axial installation space results due to the seal location. The secondary sealing element 25 seals the sealing plate 22 relative to the secondary flywheel 21 or output sun gear 13. Beyond this, the two sun gears 12 and 13 can also be supported relative to one another via a plain bearing or rolling element bearing.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed, or described or suggested form or embodiment as a general matter of design choice. It is the intention, therefore, to be limited only as indicated by the scope of the claims appended hereto.

1.-7. (canceled)

8. A torsional vibration damping arrangement for a drivetrain of a vehicle, comprising:
an input region configured to be driven in rotation around an axis of rotation (A);
an output region;
a first torque transmission path that proceeds from the input region;
a second torque transmission path that proceeds from the input region and is parallel to the first torque transmission path; and
a coupling arrangement that communicates with the output region and configured to superpose respective torques guided via the first torque transmission path and the second torque transmission path, wherein the coupling arrangement comprises:
a planetary gear set with a planet gear carrier; and
a phase shifter arrangement for the first torque transmission path configured to generate a phase shift of rotational irregularities guided via the first torque transmission path relative to rotational irregularities guided via the second torque transmission path,
wherein the phase shifter arrangement comprises:
an input element; and
an output element that comprises the planet gear carrier at which at least one planet gear is rotatably supported.

9. The torsional vibration damping arrangement according to claim 8, wherein the coupling arrangement comprises:
a superposition unit;
a first input part operatively connected to the output element of the phase shifter arrangement and to the superposition unit;
a second input part operatively connected to the input region and to the superposition unit; and
an output part configured to form the output region,
wherein the superposition unit is operatively connected to both the first input part and second input part and to the output part.

10. The torsional vibration damping arrangement according to claim 8, wherein the phase shifter arrangement comprises a vibration system having a primary mass and an intermediate element that is rotatable with respect to the primary mass around the axis of rotation (A) against an action of a spring arrangement.

11. The torsional vibration damping arrangement according to claim 10, wherein the intermediate element comprises an additional mass element connected to the planet gear carrier so as to be fixed with respect to rotation relative to the planet gear carrier.

12. The torsional vibration damping arrangement according to claim 10, wherein the planetary gear set comprises:
a drive sun gear connected to the primary mass so as to be fixed with respect to rotation relative to the primary mass; and
an output sun gear connected to the output region so as to be fixed with respect to rotation relative to the output region,
wherein the drive sun gear and output sun gear mesh with the at least one planet gear.

13. The torsional vibration damping arrangement according to claim 10, wherein the planetary gear set comprises:
a drive ring gear connected to the primary mass so as to be fixed with respect to rotation relative to the primary mass; and
an output ring gear connected to the output region so as to be fixed with respect to rotation relative to the output region,
wherein the drive ring gear and output ring gear mesh with the at least one planet gear.

14. The torsional vibration damping arrangement according to claim 8, wherein the phase shifter arrangement and the coupling arrangement are at least partially received in a wet space that is at least partially filled with a fluid.
